(19) United States
(12) Patent Application Publication
(10) Pub. No.: US 2008/0172638 A1
(43) Pub. Date: Jul. 17, 2008

(54) METHOD OF OPTIMIZING HIERARCHICAL VERY LARGE SCALE INTEGRATION (VLSI) DESIGN BY USE OF CLUSTER-BASED LOGIC CELL CLONING

(76) Inventors: Michael S. Gray, Fairfax, VT (US); David J. Hathaway, Underhill, VT (US); Jason D. Hibbeler, Williston, VT (US); Robert F. Walker, St. George, VT (US); Xin Yuan, Williston, VT (US)

Correspondence Address: DOWNS RACHLIN MARTIN PLLC, 199 MAIN ST, PO BO 190, BURLINGTON, VT, 05402-0190, US

(21) Appl. No.: 11/623,122

(22) Filed: Jan. 15, 2007

(51) Int. Cl. G06F 17/50

(52) U.S. Cl. 716/2; 716/10

(57) ABSTRACT

A method of optimizing hierarchical very large scale integration (VLSI) design by use of cluster-based cell cloning. The method of the present invention provides improved yield or migration by reusing cells in order to reduce the number of unique instances of at least one of the reused cells. The method performs hierarchal optimization on the reduced set of clones (i.e., clusters). The method of the present disclosure includes, but is not limited to, the steps of setting the initial clustering parameters; assembling the physical design from existing reused cells; for each cell type, performing a full cloning operation in order to create a full set of duplicate cells; for each cell type, performing a full optimization of the design; for each cell type, performing an analyses of all cell environments and performing a clustering operation; and analyzing the overall results in order to determine whether the optimization objectives are achieved.

### FIELD OF THE INVENTION

The present invention generally relates to the field of integrated circuit design. In particular, the present invention is directed to a method of optimizing hierarchical very large scale integration (VLSI) layout by use of cluster-based cell cloning.

### BACKGROUND

Design synthesis is a computer process that transforms a circuit description from one level of abstraction to a lower level, usually towards the physical implementation of an integrated circuit. For example, a schematic diagram is generated and then the circuit elements thereof are mapped to a set of reused elements. These reused elements may be predefined in a cell library and reused across many integrated circuit designs, or may be custom-designed for a use only within a specific integrated circuit. Subsequently, the physical layout is generated within which cells are arranged physically in multiple circuit rows and/or circuit columns in order to form the completed design. In doing so, the geometric shapes that form each cell are generated. In the hierarchical VLSI optimization process, there is sometimes an additional modification step of the initial circuit layout in order to achieve a certain objective. For example, a layout of one or more devices may be modified because a manufacturing ground rule has changed or in order to optimize manufacturing yield, circuit performance, power requirements, noise immunity, or any other electrical behavior. In particular, a mathematical optimization program is executed within any standard electronic design automation (EDA) application. The EDA application facilitates the design process. The optimization program is able to analyze, for example, all the physical relationships between geometric shapes.

In any given integrated circuit design, there are cells, such as certain logic gates in a set of library cells, that are repeated multiple times. Each cell within the set of repeated or reused cells has a set of predefined shapes associated therewith. For example, a NAND gate or a NOR gate is formed of a specific arrangement of one or more transistors. Each transistor of a specific logic gate is formed of a predefined set of geometric shapes that form the base, emitter, and collector thereof (for bipolar transistors), or the source, drain, and gate thereof (for field-effect transistors, or FETs), and that form electrical connections thereto.

Within an integrated circuit design, a cell, such as a NAND gate, may be placed multiple times within a larger unit of logic. In the hierarchical VLSI optimization process, if a shape that is part of the NAND gate (i.e., a shape of some component element of the NAND gate) is modified, it is desirable to ensure that the hierarchical structure is maintained. To achieve this, when modifying a shape that is part of a particular cell, such as the NAND gate, within a design, one must consider the most constrained environment of the design in which the NAND gate is used. More specifically, the modified NAND gate must function properly in every instance thereof within the larger layout. By way of example, if there are 25 instances of a NAND gate in a design, any change in a shape that is part of the NAND gate must be ground rule-correct and electrically correct in all 25 instances, i.e., the modified NAND gate must function properly in all 25 environments. This requirement may constrain the optimizations that may be made to the cell. Consequently, in the context of modifying a layout for VLSI optimization, the potential optimization improvements may not be realized because of one or more environments in which a cell appears.

By contrast, in order to provide maximal design flexibility for the purpose of VLSI optimization while still keeping the elements composing each cell together in the same cell, each unique usage of every cell in the hierarchy may be duplicated. In other words, all usages of each cell are broken into separate cells. As a result, each cell has a single environment only in which it is used. This duplication is referred to as “cell cloning.” Cell cloning leads to much greater flexibility in modifying the layout during the VLSI optimization process. However, a severe drawback to this approach is that the original hierarchical structure of the layout is essentially destroyed. Even though the hierarchical nesting is preserved, the cell definition is be copied and modified for each instance of the cell and, thus, the data volume that is used to represent the complete design is as large as if the design had been flattened completely. In general, circuit designers prefer that the original hierarchical structure be preserved, because it reduces data volume and avoids duplication of equivalent sub-blocks. Consequently, circuit designers prefer that the practice of cell cloning be minimized.

For these reasons, a need exists for a method of optimizing hierarchical VLSI layout in an integrated circuit design process, in order to achieve a design objective, such as to optimize manufacturing yield, circuit performance, power requirements, noise immunity, or any other property. Consequently, a need exists for a method of optimizing hierarchical VLSI layout that provides high design flexibility while, at the same time, minimizing the instances of cloned cells and, thereby, minimizing the data volume and artificial cell duplication that is the result of cell cloning.

### SUMMARY OF THE DISCLOSURE

One aspect of the disclosure is a method of optimizing a hierarchical VLSI design. The method includes the steps of cloning a first set of cells to create a corresponding set of duplicate cells, performing a design optimization using the duplicate cells and clustering ones of the set of duplicate cells having similar characteristics into one or more groups of clustered cells.

Another aspect of the disclosure is a method of laying out structures in an integrated circuit. The method includes the steps of cloning a first set of structures to create a corresponding set of duplicate structures, performing a design optimization using the duplicate structures and grouping together ones of the duplicate structures having an attribute that falls within a first parameter into one or more groups of clustered structures.

Yet another aspect of the disclosure is a computer readable medium containing computer executable instructions implementing a method of optimizing a hierarchical VLSI design. The instructions comprise a first set of instructions for cloning a first set of cells to create a corresponding set of duplicate cells, a second set of instructions for performing a design optimization using the set of duplicate cells and a third set of instructions for clustering ones of the set of duplicate cells having similar characteristics into one or more groups of clustered cells.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates a conventional cell layout in which the hierarchical structure is maintained fully;

FIG. 2 illustrates a fully cloned cell layout in which cell cloning is utilized and, thus, the hierarchical structure is not maintained because all usages of each cell are duplicated;

FIG. 3 illustrates a cluster-based cell layout that is the result of optimizing a hierarchical VLSI layout by use of cluster-based cell cloning, in accordance with the disclosure;

FIGS. 4A, 4B, and 4C illustrate a first, second, and third cell cluster, respectively, of a first cell type of the cluster-based cell layout of FIG. 3;

FIGS. 5A and 5B illustrate a first and second cell cluster, respectively, of a second cell type of the cluster-based cell layout of FIG. 3;

FIGS. 6A and 6B illustrate a first and second cell cluster, respectively, of a third cell type of the cluster-based cell layout of FIG. 3;

FIGS. 7A and 7B illustrate a first and second cell cluster, respectively, of a fourth cell type of the cluster-based cell layout of FIG. 3; and

FIG. 8 illustrates a method of optimizing hierarchical VLSI layout by use of a cluster-based cell cloning operation, in accordance with the disclosure.

### DETAILED DESCRIPTION

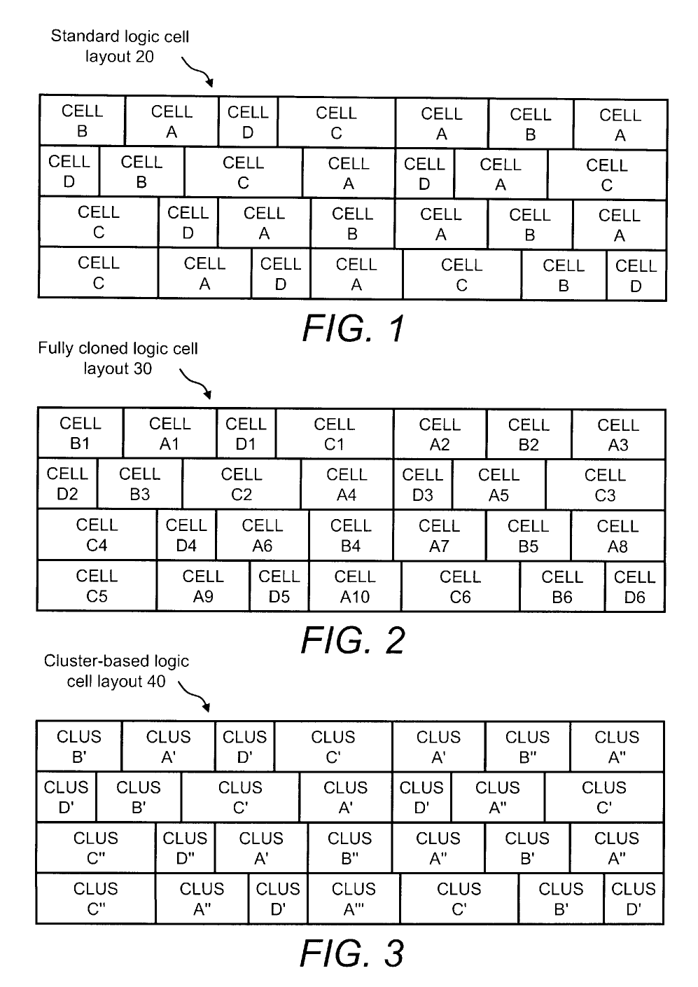

FIG. 1 illustrates a conventional cell layout 20 in which the hierarchical structure is maintained fully. Conventional cell layout 20 is representative of a portion of an integrated circuit physical design layout. FIG. 1 shows an exemplary application-specific integrated circuit (ASIC) style library element placement. More specifically, conventional cell layout 20 includes multiple instances of a first cell type that is represented by CELLs A; multiple instances of a second cell type that is represented by CELLs B; multiple instances of a third cell type that is represented by CELLs C; and multiple instances of a fourth cell type that is represented by CELLs D. Example cell types include, but are not limited to, an AND gate, a NAND gate, an OR gate, a NOR gate, an exclusive OR (XOR), and an inverter (INV), as is well known. The generation and placement of CELLs A, B, C, and D of conventional cell layout 20 is the result of a standard design synthesis process in an integrated circuit physical design process in which the hierarchical structure is maintained fully. Therefore, in the VLSI optimization process of conventional cell layout 20, if a shape that is part of, for example, CELL A is modified, one must ensure that the hierarchical structure is maintained, i.e., that modifications to the contents of CELL A are either not allowed, or that such modifications are made identically to all instances of CELL A.

In particular, when modifying a shape that is part of CELL A within conventional cell layout 20, one must consider the most constrained environment of conventional cell layout 20 in which CELL A is used. More specifically, the modified CELL A must function properly in every instance thereof within the larger layout of conventional cell layout 20. By way of example and with continuing reference to FIG. 1, there are ten instances of CELL A in conventional cell layout 20. Therefore, any change in a shape that is part of CELL A must be ground rule-correct and electrically correct in all ten instances, i.e., the modified CELL A must function properly in all ten environments. Consequently, in the context of modifying a layout hierarchically for VLSI optimization, although the data volume associated with the physical design and layout of conventional cell layout 20 is minimized because there is one set only of data for each cell type, the potential optimization improvements of conventional cell layout 20 may not be realized because of constraints imposed by one or more environments in which a cell, such as CELL A, B, C, or D, appears.

FIG. 2 illustrates a fully cloned cell layout 30 in which cell cloning is utilized and, thus, the hierarchical structure is not maintained because all usages of each cell are duplicated. More specifically and referring again to FIG. 1, each unique usage of CELL A, B, C, or D in the hierarchy of conventional cell layout 20 of FIG. 1 is duplicated, i.e., cloned. For example, CELL A of conventional cell layout 20 of FIG. 1 is cloned for all instances thereof, which results in a CELL A1 through A10 in fully cloned cell layout 30 of FIG. 2. Similarly, CELL B of conventional cell layout 20 of FIG. 1 is cloned for all instances thereof, which results in a CELL B1 through B6 in fully cloned cell layout 30 of FIG. 2. Similarly, CELL C of conventional cell layout 20 of FIG. 1 is cloned for all instances thereof, which results in a CELL C1 through C6 in fully cloned cell layout 30 of FIG. 2. Similarly, CELL D of conventional cell layout 20 of FIG. 1 is cloned for all instances thereof, which results in a CELL D1 through D6 in fully cloned cell layout 30 of FIG. 2.

Fully cloned cell layout 30 provides maximal design flexibility for the purpose of hierarchical VLSI optimization, as each unique usage of every cell of every cell type in the hierarchy is duplicated but the cells themselves are not flattened. As a result, each cell of fully cloned cell layout 30 has a single environment only in which it is used and in which its constituent shapes may be modified for the purpose of achieving a better result during optimization. While fully cloned cell layout 30 provides maximal flexibility in modifying the layout during the hierarchical VLSI optimization process, fully cloned cell layout 30 has a severe drawback in that the original hierarchical structure of conventional cell layout 20 of FIG. 1 is essentially destroyed. In particular, the cell definitions of reused CELLs A, B, C, and D are copied and modified for each instance thereof and, thus, the data volume that is used to represent the complete design of fully cloned cell layout 30 is large as compared with that of conventional cell layout 20 of FIG. 1. Additional details of a cluster-based cell layout that provides a novel alternative to conventional cell layout 20 of FIG. 1 and fully cloned cell layout 30 of FIG. 2 are described with reference to FIGS. 3 through 8.

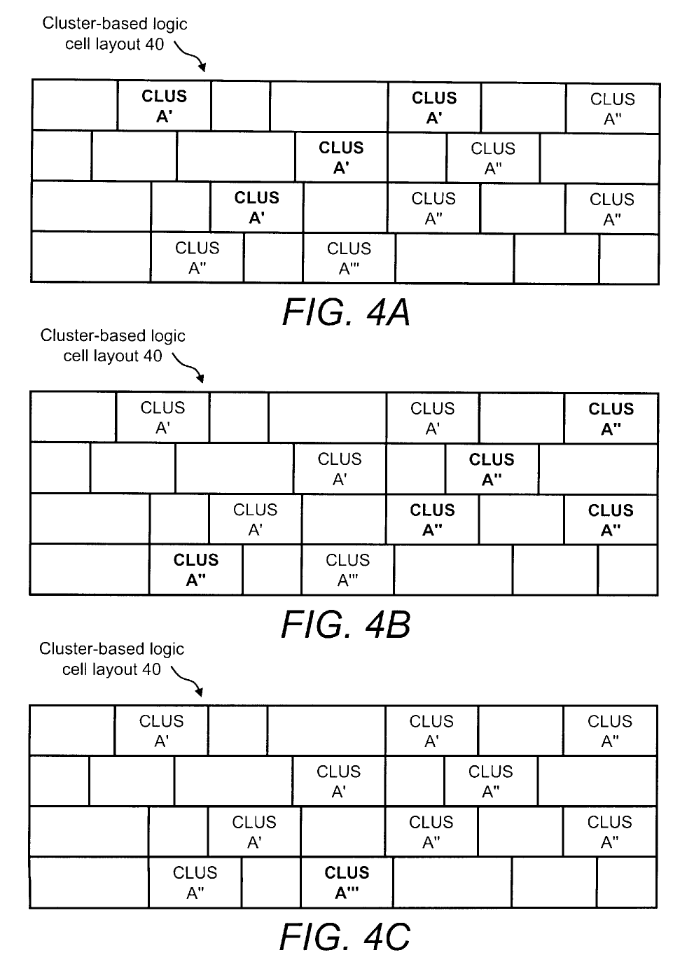

FIG. 3 illustrates a cluster-based cell layout 40 that is the result of optimizing a hierarchical VLSI layout by use of cluster-based cell cloning, in accordance with the disclosure. For each cell type, cluster-based cell layout 40 includes one or more clusters of cells. Referring again to FIG. 2, fully cloned cell layout 30 includes, for example, CELLs A1 through A10, which may each be modified uniquely (i.e., optimized) in their respective environments and, thus, fully cloned cell layout 30 allows maximal design optimization while still preserving the cell structure of A. Alternatively, the results of the optimization of CELLs A1 through A10 of fully cloned cell layout 30 is analyzed in order to determine whether certain of CELLs A1 through A10 possess sufficiently similar (often substantially identical) properties, e.g., physical and/or electrical characteristics, according to some predefined design criterion. Cluster-based cell layout 40 of FIG. 3 illustrates the result of CELLs A1 through A10 of fully cloned cell layout 30 of FIG. 2 being further analyzed to identify cells of similar properties and the subsequent formation of subgroups, or clusters, of substantially identical cells. For example, cluster-based cell layout 40 of FIG. 3 includes a cluster (CLUS) A′, a CLUS A″ and a CLUS A′″, which replaces CELL A1 through A10 of fully cloned cell layout 30 of FIG. 2. More details of CLUS A′, CLUS A″ and CLUS A′″ are described with reference to FIGS. 4A, 4B, and 4C.

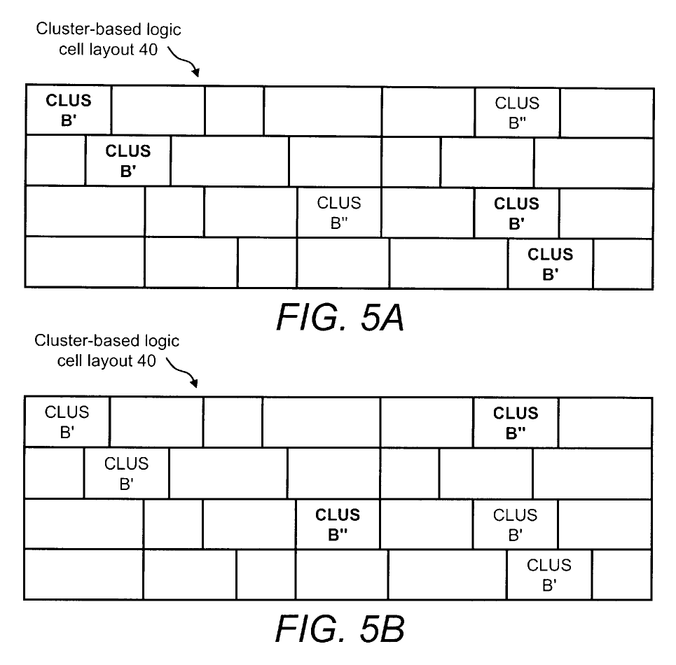

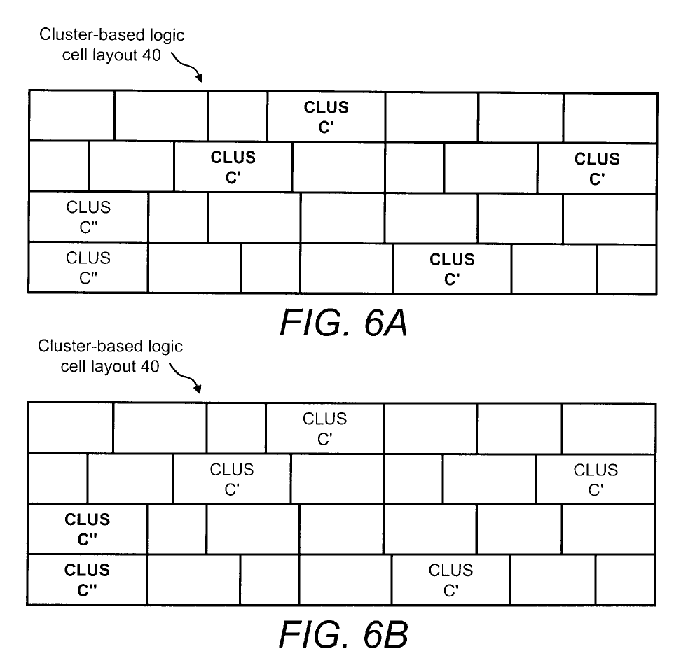

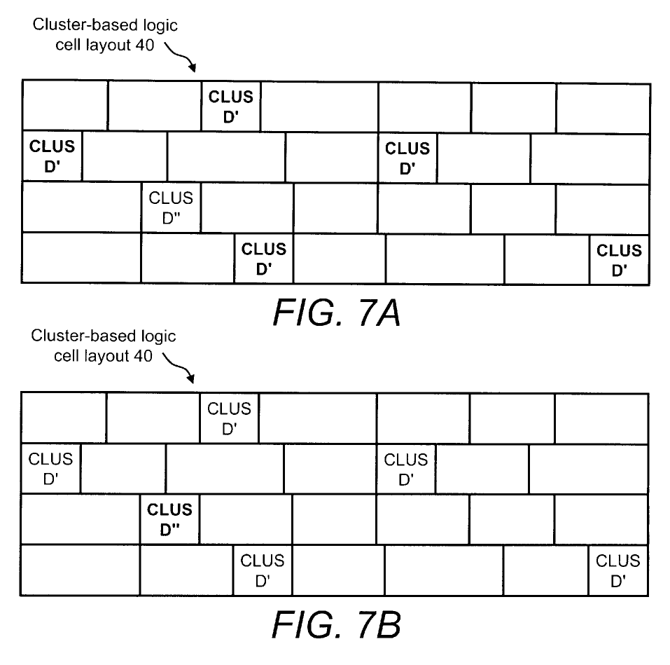

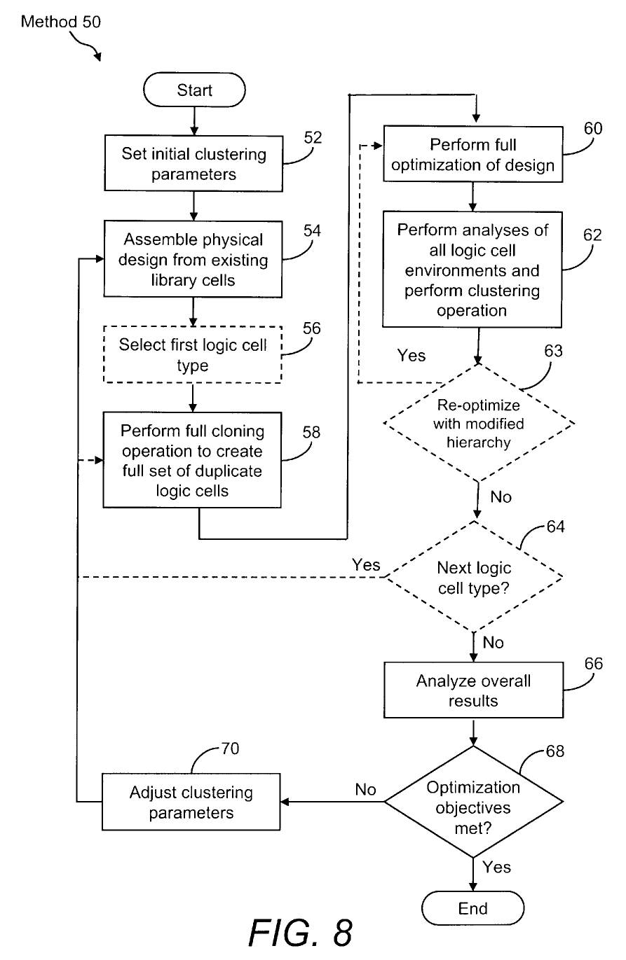

Similarly, cluster-based cell layout 40 of FIG. 3 includes a CLUS B′ and a CLUS B″, which replaces CELL B1 through B6 of fully cloned cell layout 30 of FIG. 2. More details of CLUS B′ and CLUS B″ are described with reference to FIGS. 5A and 5B. Similarly, cluster-based cell layout 40 of FIG. 3 includes a CLUS C′ and a CLUS C″, which replaces CELL C1 through C6 of fully cloned cell layout 30 of FIG. 2. More details of CLUS C′ and CLUS C″ are described with reference to FIGS. 6A and 6B. Similarly, cluster-based cell layout 40 of FIG. 3 includes a CLUS D′ and a CLUS D″, which replaces CELL D1 through D6 of fully cloned cell layout 30 of FIG. 2. More details of CLUS D′ and CLUS D″ are described with reference to FIGS. 7A and 7B. Additionally, a method of determining the various clusters, as shown in cluster-based cell layout 40 of FIG. 3, is described with reference to FIG. 8.

FIGS. 4A, 4B, and 4C illustrate a first, second, and third cell cluster, respectively, of a first cell type of cluster-based cell layout 40 of FIG. 3. More specifically, FIG. 4A highlights CLUS A′ of cluster-based cell layout 40, which is formed of a first instance of reused CELL A of conventional cell layout 20 of FIG. 1 that is placed in four environments. Similarly, FIG. 4B highlights CLUS A″ of cluster-based cell layout 40, which is formed of a second instance of reused CELL A of conventional cell layout 20 of FIG. 1 that is placed in five environments. Similarly, FIG. 4C highlights CLUS A′″ of cluster-based cell layout 40, which is formed of a third instance of reused CELL A of conventional cell layout 20 of FIG. 1 that is placed in one environment only. CLUS A′, CLUS A″ and CLUS A′″ of cluster-based cell layout 40 are illustrated in separate figures, i.e., FIGS. 4A, 4B and 4C, respectively, merely for purposes of illustrating the different cell clusters. As implemented, CLUS A′, CLUS A″ and CLUS A′″ are part of a single cluster-based cell layout 40, as illustrated in FIG. 3.

In the example shown in FIGS. 4A, 4B, and 4C, the three clusters of reused CELL A, i.e., CLUS A′, CLUS A″, and CLUS A′″, within cluster-based cell layout 40 of FIG. 3 represent three cell cloning operations, i.e., standard CELL A of conventional cell layout 20 of FIG. 1 is cloned three times. This manner of cell cloning is the result of performing an optimization of CELLs A1 through A10 of fully cloned cell layout 30 and, subsequently, analyzing the results and determining that the optimized versions of the optimized versions of CELL A1, A2, A4, and A6 possess sufficiently similar (often substantially identical) properties and, thus, may be clustered to form CLUS A′, that CELL A3, A5, A7, A8, and A9 possess sufficiently similar (often substantially identical) properties and, thus, may be clustered to form CLUS A″, and that CELL A10 alone possesses unique properties and, thus, is clustered to form CLUS A′″. The optimized results of a cell are determined both by the intrinsic properties of the cell itself and also by the interaction of the cell with its environment. As a result, the optimization of cluster-based cell layout 40 of FIG. 3 involves the modification of a first instance of reused CELL A, which applies to each of the four environments of CLUS A′; the modification of a second instance of reused CELL A, which applies to each of the five environments of CLUS A″; and the modification of a third instance of reused CELL A, which applies to the one environment only of CLUS A′″. More details of forming clusters, such as CLUS A′, CLUS A″, and CLUS A′″, are described with reference to FIG. 8.

Whereas CLUS A′, CLUS A″, and CLUS A′″ of cluster-based cell layout 40 of FIG. 3 are the result of three cell cloning operations, by contrast, all instances of reused CELL A of conventional cell layout 20 of FIG. 1 are the result of no cell cloning operations and CELL A1 through A10 of fully cloned cell layout 30 of FIG. 2 are the result of ten cell cloning operations, i.e., reused CELL A is cloned ten times. The creation of CLUS A′, CLUS A″, and CLUS A′″ of cluster-based cell layout 40 of FIG. 3 is representative of an optimized design that balances the trade-offs between hierarchical flattening and available optimization resources (e.g., processing time, memory, and libraries).

FIGS. 5A and 5B illustrate a first and second cell cluster, respectively, of a second cell type of cluster-based cell layout 40 of FIG. 3. More specifically, FIG. 5A highlights CLUS B′ of cluster-based cell layout 40, which is formed of a first instance of reused CELL B of conventional cell layout 20 of FIG. 1 that is placed in four environments. Similarly, FIG. 5B highlights CLUS B″ of cluster-based cell layout 40, which is formed of a second instance of reused CELL B of conventional cell layout 20 of FIG. 1 that is placed in two environments. CLUS B′ and CLUS B″ are formed by grouping cells (i.e., grouping CELLs B 1 through B6 of fully cloned cell layout 30 of FIG. 2) that possess sufficiently similar (often substantially identical) properties after optimization, as described with reference to FIGS. 4A, 4B, and 4C and further described with reference to FIG. 8. Again, as with FIGS. 4A, 4B and 4C, CLUS B′ and CLUS B″ are illustrated in separate FIGS. 5A and 5B, respectively, for ease of description. The CLUS B′ and CLUS B″ are, as implemented, part of a single cluster-based cell layout 40.

FIGS. 6A and 6B illustrate a first and second cell cluster, respectively, of a third cell type of cluster-based cell layout 40 of FIG. 3. More specifically, FIG. 6A highlights CLUS C′ of cluster-based cell layout 40, which is formed of a first instance of reused CELL C of conventional cell layout 20 of FIG. 1 that is placed in four environments. Similarly, FIG. 6B highlights CLUS C″ of cluster-based cell layout 40, which is formed of a second instance of reused CELL C of conventional cell layout 20 of FIG. 1 that is placed in two environments. CLUS C′ and CLUS C″ are formed by grouping cells (i.e., grouping CELLs C1 through C6 of fully cloned cell layout 30 of FIG. 2) that possess sufficiently similar (often substantially identical) properties after optimization, as described with reference to FIGS. 4A, 4B, and 4C and further described with reference to FIG. 8. Here too, CLUS C′ and CLUS C″ are illustrated in separate figures, i.e., FIGS. 6A and 6B, for purposes of description. As implemented, they are included in cluster-based cell layout 40.

FIGS. 7A and 7B illustrate a first and second cell cluster, respectively, of a fourth cell type of cluster-based cell layout 40 of FIG. 3. More specifically, FIG. 7A highlights CLUS D′ of cluster-based cell layout 40, which is formed of a first instance of reused CELL D of conventional cell layout 20 of FIG. 1 that is placed in five environments. Similarly, FIG. 7B highlights CLUS D″ of cluster-based cell layout 40, which is formed of a second instance of reused CELL D of conventional cell layout 20 of FIG. 1 that is placed in one environment only. CLUS D′ and CLUS D″ are formed by grouping cells (i.e., grouping CELLs D1 through D6 of fully cloned cell layout 30 of FIG. 2) that possess sufficiently similar (often substantially identical) properties after optimization, as described with reference to FIGS. 4A, 4B, and 4C and further described with reference to FIG. 8. Again, CLUS D′ and CLUS D″ are included in cluster-based cell layout 40, and are illustrated separately in FIGS. 7A and 7B for clarity of description.

Although the example of FIGS. 1-7 shows cell instances in particular locations within a design layout the incentive method may be applied to design optimization steps and processes for which no layout exists. For example, a design might be represented as a netlist specifying the logical interconnection between unplaced cells of a design (e.g., a circuit schematic), and the properties of the cells to be optimized might include electrical or other characteristics of those cells.

FIG. 8 illustrates a method 50 of optimizing hierarchical VLSI layout by use of a cluster-based cell cloning operation, in accordance with the disclosure.

At step 52, the clustering parameters are set for a given integrated circuit design based, for example, on one or more optimization objectives for the VLSI layout. Example optimization objectives include, but are not limited to, (1) compensating for a manufacturing ground rule change, (2) achieving a certain manufacturing yield, (3) achieving a certain circuit performance, (4) achieving a certain power requirement, (5) achieving a certain noise immunity, or (6) achieving any other electrical behavior. Additionally, clustering parameters are set in order to target a certain physical region of the integrated circuit layout or to set the maximum area for optimization to a certain size, as there may be some advantage to concentrating the optimization operation to certain sized regions. Furthermore, a “sensitivity” parameter may be set, i.e., less sensitivity results in larger clusters, more sensitivity results in smaller clusters. Method 50 proceeds to step 54.

At step 54, the initial synthesis operation on a given integrated circuit design is executed in order to assemble the design from a set of existing reused cells. The synthesis operation is performed by use of any standard EDA application that is suitable for facilitating a design process. The result of an initial synthesis operation is, for example, conventional cell layout 20 of FIG. 1. Method 50 proceeds to step 56.

At step 56, within any standard EDA application a first cell type is selected for executing the optimization routine thereon. Referring again to conventional cell layout 20 of FIG. 1, CELL A, CELL B, CELL C, and CELL D are representative of four different cell types. CELL A is, for example, an AND gate; CELL B is, for example, a NAND gate; CELL C is, for example, an OR gate; and CELL D is, for example, an INV. By way of example, in this step, CELL A is selected for executing the optimization routine thereon. Step 56 is identified with a dotted box in FIG. 8 to indicate that this step is optional. In some applications it will be desirable to omit this step, as discussed more below in connection with step 58. Method 50 proceeds to step 58.

At step 58, a full cloning operation on the selected cell type is performed, assuming step 56 is included and so just one cell type is selected, in order to create a full set of duplicate cells, such as illustrated with reference to fully cloned cell layout 30 of FIG. 2. In a first example, each unique usage of CELL A of conventional cell layout 20 of FIG. 1 is cloned, which results in CELL A1 through A10 of fully cloned cell layout 30 of FIG. 2. In a second example, each unique usage of CELL B of conventional cell layout 20 of FIG. 1 is cloned, which results in CELL B1 through B6 of fully cloned cell layout 30 of FIG. 2. In a third example, each unique usage of CELL C of conventional cell layout 20 of FIG. 1 is cloned, which results in CELL C1 through C6 of fully cloned cell layout 30 of FIG. 2. In a fourth example, each unique usage of CELL D of conventional cell layout 20 of FIG. 1 is cloned, which results in CELL D1 through D6 of fully cloned cell layout 30 of FIG. 2. This full cloning operation does not require that a complete separate copy of a reused cell be created for each instance of that cell. Instead, it might simply allow the value of at least one parameter of each instance of the cell type (e.g., the location of an edge of a shape within the cell) to vary independently from the corresponding parameter values of all other instances of the cell type during the subsequent optimization process of step 60. If step 56 is excluded, then the full cloning operation of step 58 is performed with regard to all logic cells presented at the cloning operation, regardless of logic cell type. Method 50 proceeds to step 60.

At step 60, within any standard EDA application, an optimization method is executed on the design containing the full set of duplicated cells for the selected cell type. This design optimization may be performed using well-known optimization programs. For example, an optimization program may be executed on the design containing CELL A1 through A10, CELL B1 through B6, CELL C1 through C6, or CELL D1 through D6 of fully cloned cell layout 30 of FIG. 2. In doing so, the geometric shapes that form CELL A1 through A10, CELL B1 through B6, CELL C1 through C6, or CELL D1 through D6 of fully cloned cell layout 30 of FIG. 2 are modified to meet the objective(s) of the optimization routine. As is known, and as discussed above, optimization may be performed to achieve one or more objectives, including, for example, (1) compensating for a manufacturing ground rule change, (2) achieving a certain manufacturing yield, (3) achieving a certain circuit performance, (4) achieving a certain power requirement, (5) achieving a certain noise immunity, or (6) achieving any other electrical behavior. Method 50 proceeds to step 62.

At step 62, for the selected cell types, analyses of all cell environments are performed, and the cloned instances of the selected cell type are clustered. In particular, a cell, such as CELL A1 through A10, CELL B1 through B6, CELL C1 through C6, or CELL D1 through D6 of fully cloned cell layout 30 of FIG. 2, contains shapes that have edges and each of these edges is represented by a variable. Each original edge variable in A then corresponds, for example, to ten separate edge variables in A1, A2, . . . , A10. Thus, an analysis of the shape and edge placement across all cloned cells of a given cell is performed. For example, an analysis is performed to determine which cells have similar attributes or parameters, such as analyzing the x-y coordinates of edges and analyzing the relative edge placement (e.g., spacing and/or size) with respect to other edges in that cell and in that cell's environment. Other circuit parameters, e.g., transistor width, may also be defined by variables, and the above-described analysis may be performed with respect to such other variables.

More specifically, clustering is the process of dividing a set of data points into groups, i.e., clusters, within which members of the same cluster are more “similar” to each other than to members of different clusters. A clone of a cell is represented by the values of the N variables that specify the properties of the clone. For example, the unique characteristics of a clone of a particular cell type, e.g., CELL A, might be characterized by the X coordinate variables of four different edges, Q, R, S, and T relative to the origin of the cell, and a particular clone, e.g., CELL A1, might be described by a set of values for those variables, e.g., (5, 6, 3, 2). Such a set of N values may be considered a point in N-dimensional space, with each of the N variable values being a coordinate in that space. It is these points, each of which represents an instance in the fully cloned layout, that will be clustered. This clustering process will include determination of distances between various pairs of points in this N-dimensional space. According to one method, known as an L-1 norm, a distance between a pair of points is simply the sum of the absolute values of the differences between the respective coordinate values. For example, the L-1 norm distance between points (1,4,8,3) and (2,6,6,2) in 3-dimensional space would be abs(1−2)+abs(4−6)+abs(8−6)+abs(3−2)=6. Other distances measures, including a Euclidian or L-2 norm are well-known and may be used to determine a centroid location. Different weighting factors may applied to different coordinate dimensions to adjust the relative importance of the various parameters that characterize the cell instance or clone. If in the previous example the first coordinate had a weight of 5 relative to the other coordinates, the weighted L-1 norm distance would then be 5*abs(1−2)+abs(4−6)+abs(8−6)+abs(3−2)=10. The centroid of a set of points in N-dimensional space is defined as the point with respect to which the sum of the distances from the points of the set is the smallest.

The set of parameters or variables that characterize an instance of a cell type may include, but are not limited to, any or all of: relative coordinates or positions of edges of shapes within the cell instance, and widths, lengths, threshold voltages, gate insulator thicknesses, or other parameters of transistors within the cell instance.

A partitioning is a set of clusters. For example, if there are N points that one wishes to cluster into k groups, it is desired to assign points that are similar to the same cluster. Therefore, for one of the k clusters, it is desired that the sum of the distances between each point and a reference or representative point of the cluster to which it is assigned be small.

In cluster analysis, the error measure E is the sum of distances,

where

$$E = {\sum }_{i = 1}^{k} {\sum }_{j = 1}^{{N}_{i}} {dist ( {X}_{ij} - {Z}_{i} )}^{2} ;$$

and

where Xᵢⱼ is the jth point in the ith cluster, Zᵢ is the reference point of the ith cluster,

and Nᵢ is the number of points in that cluster.

It is desired to minimize E, as the smaller the E, the better the clustering. Various alternative clustering methods may use different error functions E. For example, rather than setting E equal to the sum of the distances between the clustered points and the reference points of their clusters, it may be set equal to the variance of these distances (i.e., the sum of the squares of the distances).

Many different methods are known for clustering a set of N points into points k clusters. One such method is “k-means clustering”, which is an iterative clustering algorithm which minimizes E and within which it is known what value of k is desired. The steps of the iterative clustering algorithm include, but are not limited to, the following:
1. An initial partitioning is set up:
   a. k reference points are picked from the set of N points; each reference point is a cluster;
   b. each of the remaining points is assigned to a cluster that contains the reference point to which that point is closest;
2. the centroid of each cluster is computed and used as a new reference point;
3. points are reassigned to clusters using the new reference points; and
4. steps 2 and 3 are repeated until there are no changes in the clusters and, thus, E reaches a local minimum.

Minor variations on k-means clustering involve recomputing the centroids after every assignment or after every few assignments. In doing so, the convergence speed is improved. The present disclosure encompasses clustering operations known to those skilled in the art other than k-mean clustering. In this regard, k-means clustering should be considered merely one example of clustering operations that may be used.

The k-means clustering method described above may be used when the desired value of k is known. Alternatively, a maximum value of E may be specified. In this case a small initial value of k may be chosen after which k-means clustering performed and the value of E is computed. If the resulting value of E is larger than the allowed maximum, k is increased and the clustering and E computation is repeated until the E limit is satisfied. Yet another alternative determines a clustering which provides a good balance between a small cluster count k and a small error measure E. For example, compute E for k=1 to N clusters, stopping when E does not significantly improve from the i-1 th to the ith clustering. Method 50 proceeds, optionally, to step 63.

In some cases the clustering operation performed in step 62 may not be legal with regard to the constraints of the optimization problem, or in other ways may not be ideally optimized. Step 63 may optionally be included for the purpose of sending the modified design hierarchy back to step 60 for re-optimization. Step 63 is indicated with a dotted box in FIG. 8 to indicate that it is optional. Use of step 63 enforces rules of the design and ensures modification, at step 60, of any design that is not legal relative to the predetermined design constraints of the problem. Use of step 63 may also result in adjustment of the design so as to produce the best overall values. For example, in the cluster-based cell layout of FIG. 3, the optimization could initially be restricted such that all cells A′ are assigned the same parameters, and similarly all cells in each of the groups labeled A″, A′″, B′, B″, C′, C″, D′, and D″ could be assigned the same parameters. But the parameters for groups A′, A″, and A′″ could be assigned differently via a second or other subsequent iteration through step 60, as could the parameters for groups B′ and B″, for groups C′ and C″, and for groups D′ and D″. In this way the parameters of the elements of each cluster may be adjusted to the best values for the overall design.

At decision step 64, it is determined whether another cell type exists within the design for which optimization is required. This step 64 is identified as a dotted decision box in FIG. 8 to indicate that the step is optional, and is typically used only when step 56 is included. If the decision at step 64 is yes, a next cell type is selected and method 50 returns to step 58. If no, method 50 proceeds to step 66. Alternatively, the optimization and clustering steps may be performed after all cell types have been fully cloned, i.e., after step 64. This may be beneficial when the optimization process simultaneously optimizes all cell types of the design, as may occur when the optimum parameter values for the cell instances of the different cell types cannot be determined independently. In this case the full cloning of all cell types is performed first (steps 58 and 64 being omitted), then optimization step 60 is performed to set instance parameters for all instances of all cell types, and finally clustering step 62 is performed for each cell type.

At step 66, the overall results of the cluster-based cell cloning operation for the purpose of optimizing a hierarchical VLSI layout, which is performed in steps 52 through 64, is analyzed. For example, the results are analyzed against one or more optimization objectives for the VLSI layout. Example optimization objectives include, but are not limited to, (1) compensating for a manufacturing ground rule change, (2) achieving a certain manufacturing yield, (3) achieving a certain circuit performance, (4) achieving a certain power requirement, (5) achieving a certain noise immunity, or (6) achieving any other electrical behavior. Method 50 proceeds to step 68.

At decision step 68, based on the results of the analysis at step 66, is it determined whether the overall results of the cluster-based cell cloning operation meet the optimization objectives. If yes, method 50 ends and the result is, for example, cluster-based cell layout 40 of FIG. 3. If no, method 50 proceeds to step 70.

At step 70, the clustering parameters are adjusted. For example, the sensitivity parameter is adjusted, e.g., less sensitivity results in larger clusters, more sensitivity results in smaller clusters. Method 50 returns to step 54.

In summary, method 50 of the present invention produces, for example, cluster-based cell layout 40 of FIG. 3. The cells of each cluster, such as of CLUS A′, A″, A′″, B′, B″, C′, C″, D′, and D″, are the same version of a reused cell (i.e., one set of data), respectively, and their environments are substantially identical such that any modification thereto is acceptable according to ground rules. In doing so, increased design flexibility (e.g., customization) is achieved without the need for cloning every cell and, thus, the amount of duplicate data is minimized. In particular, method 50 of the present invention performs hierarchial optimization on a reduced set of clones (i.e., clusters). The result is an optimized design that balances the trade-offs between hierarchical flattening and available optimization resources (e.g., processing time, memory, and libraries).

An exemplary embodiment has been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A method of optimizing a hierarchical VLSI design, comprising the steps of:
cloning a first set of cells to create a corresponding set of duplicate cells;
performing a design optimization using said duplicate cells; and
clustering ones of said set of duplicate cells having similar characteristics into one or more groups of clustered cells.

2. A method according to claim 1, wherein said clustering step is performed so that each clustered cell in said one or more groups of cells is represented with substantially identical data.

3. A method according to claim 1, following said clustering step, determining whether optimization objectives for the VLSI design have been met.

4. A method according to claim 1, wherein said clustering step involves clustering said ones of said set of duplicate cells in accordance with clustering parameters, the method further including the step, after said clustering step, of evaluating whether optimization objectives for the VLSI design have been met.

5. A method according to claim 4, further including the step of modifying said clustering parameters and repeating said performing step and said clustering step.

6. A method according to claim 1, wherein said clustering step is performed so that ones of said set of duplicate cells having substantially identical physical or electrical characteristics are clustered into a group of clustered cells.

7. A method according to claim 1, wherein said clustering step is performed using k-means clustering.

8. A method according to claim 1, wherein following said clustering step said performing a design optimization step is repeated.

9. A method of laying out structures in an integrated circuit, comprising the steps of:
cloning a first set of structures to create a corresponding set of duplicate structures;
performing a design optimization using said duplicate structures; and
grouping together ones of said duplicate structures having an attribute that falls within a first parameter into one or more groups of clustered structures.

10. A method according to claim 9, wherein said performing step involves substituting said one or more groups of clustered structures for said first set of structures.

11. A method according to claim 9, wherein said grouping step is performed using k-means clustering.

12. A method according to claim 9, wherein said grouping step is performed so that each clustered structure in said one or more groups of clustered structures is represented with substantially identical data.

13. A method according to claim 9, following said performing step, determining whether optimization objectives for the VLSI design have been met.

14. A method according to claim 9, further including modifying said first parameter and repeating said performing step and said grouping step.

15. A method according to claim 9, wherein said grouping step is performed so that ones of said set of duplicate structures having substantially identical physical or electrical characteristics are clustered into a group of clustered structures.

16. A method according to claim 9, wherein said cloning step involves selecting said first set of structures so they are all the same type of cell.

17. A computer readable medium containing computer executable instructions implementing a method of optimizing a hierarchical VLSI design, the instructions comprising:
a first set of instructions for cloning a first set of cells to create a corresponding set of duplicate cells;
a second set of instructions for performing a design optimization using said set of duplicate cells; and
a third set of instructions for clustering ones of said set of duplicate cells having similar characteristics into one or more groups of clustered cells.

18. A computer readable medium according to claim 17, wherein said third set of instructions perform said clustering so that each clustered cell in said one or more groups of cells may be represented with substantially identical data.

19. A computer readable medium according to claim 17, wherein said third set of instructions perform said clustering using clustering parameters, the method including a fourth set of instructions for determining whether optimization objectives for the VLSI design have been met, further wherein said second set of instructions and said third set of instructions are executed again using modified clustering parameters selected following a determination that said optimization objectives have not been met.

20. A computer readable medium according to claim 17, wherein said third set of instructions involve performing said clustering using k-means clustering.
